(19) United States
(12) Patent Application Publication
(10) Pub. No.: US 2011/0207372 A1
(43) Pub. Date: Aug. 25, 2011

(54) Electrical Connector With Push-In Termination

(75) Inventor: Dennis M. Breen, IV, West Chicago, IL (US)

(73) Assignee: IDEAL INDUSTRIES, INC., Sycamore, IL (US)

(21) Appl. No.: 13/029,312

(22) Filed: Feb. 17, 2011

Related U.S. Application Data
(60) Provisional application No. 61/306,713, filed on Feb. 22, 2010.

(51) Int. Cl. H01R 24/00; H01R 4/48

(52) U.S. Cl. 439/629; 439/729; 439/660

(57) ABSTRACT

An electrical connector having a housing adapted to receive at least one conductor of a stripped end of a wire, the electrical connector further including at least one terminal assembly, wherein the at least one terminal assembly includes a retention member adapted to engage the at least one conductor via a push-in wire termination. The housing may be configured with a cap that engages the housing and which can be pressed to permit a respective conductor to be inserted into or removed from a corresponding wire entry port. The cap may include a port through which the at least one conductor passes. The housing may have a first portion adapted to receive an edge of a printed circuit board and a second portion adapted to receive the at least one conductor of a stripped end of a wire.

### CROSS-REFERENCE TO RELATED APPLICATION

This application claims the benefit of U.S. Provisional Patent Application Ser. No. 61/306,713, filed on Feb. 22, 2010, the disclosure of which is hereby incorporated by reference in its entirety.

### BACKGROUND

This disclosure relates to electrical connectors having a terminal assembly for making an electrical connection via push-in termination with a conductor of a stripped end of a wire, while being configured for zero insertion force or releasable termination of a wire. Such electrical connectors also may provide for connection to one or more additional conductors of stripped ends of wires, a printed circuit board or another electrical apparatus

Various types of electrical connectors exist, some of which for example are referred to as card edge electrical connectors, which will be used to illustrate features in the present disclosure. The disclosed electrical connectors may be particularly useful in applications such as where it is desired to connect a plurality of electrical apparatus, such as in a daisy chaining manner

For instance, it would be desirable to permit wiring connection to an electrical apparatus, such as with recessed lighting, which allows for a quick and simple method of replacing an electronic ballast or Light Emitting Diode (LED) driver. The push-in termination of wires to an electrical connector allows for simple assembly of wires, a fixture or other electrical apparatus. Additionally, the push-in wire terminations may be configured, such as to be routed through a movable cap, to permit zero insertion force or releasable termination of each wire. Indeed, the example electrical connectors of this disclosure would allow a “quick release” of a releasable conductor or of a ballast/driver from the wiring of a light fixture without having to cut, remove or expose potentially hazardous wires.

Generally if an individual wants to alter the wiring of an electrical apparatus that includes push-in termination, such as to replace the apparatus, the wires to the apparatus would have to be cut and have the insulation at their ends stripped to reveal anew the conductor of the wires. For instance, to replace a ballast or change an installed light fixture from a Compact Fluorescent Light (CFL) to a newer technology, such as LED, the entire fixture would have to be replaced. However, if the CFL fixture were to utilize an electrical connector of the new type taught herein, such as in the form of a new card edge electrical connector, the individual would be able to “quick release” the electronic ballast and replace the ballast or install a new LED driver that is compatible with the card edge electrical connector. Then, the old CFL bulb could be replaced with a new LED bulb. This is a much simpler and less expensive method of replacing a ballast/driver or upgrading a recessed light fixture.

While discussed with respect to examples involving light fixtures and lighting systems, it will be appreciated that the disclosed electrical connectors could be incorporated into other electrical apparatus and systems. Accordingly, while the present disclosure shows and demonstrates various example components, the examples are merely illustrative and are not to be considered limiting. It will be apparent to those of ordinary skill in the art that various electrical connectors, electrical apparatus and systems can be constructed without departing from the scope or spirit of the present disclosure. Thus, although certain examples have been described herein, the scope of coverage of this patent is not limited thereto.

### SUMMARY

According to a first aspect of the disclosure, there is provided an electrical connector having a housing adapted to receive at least one conductor of a stripped end of a wire, the electrical connector further including at least one terminal assembly, wherein the at least one terminal assembly includes a retention member adapted to releasably engage the at least one conductor via a push-in wire termination, with the housing including a cap having a port through which the at least one conductor passes.

According to a second aspect of the disclosure, there is provided an electrical connector having a housing that includes a first portion adapted to receive an edge of a printed circuit board along a first axis and a second portion adapted to receive at least one conductor of a stripped end of a wire along a second axis which is perpendicular to the first axis, the electrical connector further includes at least one terminal assembly, wherein a first portion of the at least one terminal assembly is adapted to releasably engage a contact on a printed circuit board that is in the form of a contact pad or circuit trace, and a second portion of the at least one terminal assembly is adapted to releasably engage the at least one conductor via a push-in wire termination.

The wire termination may utilize a zero insertion force configuration that includes a cap that engages the housing of the electrical connector adjacent the second face of the housing. The cap includes a bottom portion adapted to engage a retention member and to compress the retention member when the cap is moved to a first position. The cap further includes a top portion adapted to receive the conductor and to provide a surface to be pressed when seeking to move the cap to the first position.

The retention member is of resilient construction, such as in the form of a spring member, and is configured so that when compressed by the cap, it allows for insertion of the conductor with little to no insertion force. When the cap is moved to a second position, the retention member is allowed to engage an inserted conductor, such that removal of the conductor cannot occur without significant force or damage to the conductor. In the examples shown, the cap slidably engages the housing of the electrical connector. However, it will be appreciated that the cap could be attached to the housing in a manner in which it is not slidable and would allow the conductor to be inserted to achieve engagement with the retention member. The retention member also is adapted to press the conductor into engagement with a terminal assembly, thus providing an electrical connection between the conductor of a stripped end of a wire and the respective circuitry of the circuit board.

### BRIEF DESCRIPTION OF THE DRAWINGS

FIG. 1 is a front perspective view of a first example electrical connector with a first portion having a first face adapted and a second portion having a second face.

FIG. 2 is a front perspective exploded view of the electrical connector shown in FIG. 1.

FIG. 3 is a section view of the electrical connector shown in FIG. 1, with a cap moved to a first position in which it is pressed down to compress a retention member.

FIG. 4 is a section view of the electrical connector shown in FIG. 1, with the cap moved to a second position in which it is released.

FIG. 5 is a section view of the electrical connector shown in FIG. 1, with the cap moved to the first position in which it is pressed down to compress a retention member while a conductor is inserted.

FIG. 6 is a section view of the electrical connector shown in FIG. 1, with the cap moved to a third position in which it is released and allows the retention member to engage an inserted conductor.

FIG. 7 is a front perspective exploded view of another example electrical connector, with a top portion including a cap and being adapted to receive more than one conductor.

FIG. 8 is a section view of the electrical connector shown in FIG. 7, with the cap moved to a first position in which it is pressed down to compress a retention member.

FIG. 9 is a section view of the electrical connector shown in FIG. 7, with the cap moved to a second position in which it is released.

FIG. 10 is a section view of the electrical connector shown in FIG. 7, with the cap moved to a first position in which it is pressed down to compress a retention member while two conductors are inserted.

FIG. 11 is a section view of the electrical connector shown in FIG. 7, with the cap moved to a third position in which it is released and allows the retention member to engage two inserted conductors.

FIG. 12 is a front perspective view of another example electrical connector, having a housing configured to enclose more than one terminal assembly and showing conductors of stripped ends of wires in a position just prior to being inserted.

FIG. 13 is a front perspective view of the electrical connector shown in FIG. 12, with the conductors of stripped ends of wires inserted.

FIG. 14 is a front perspective exploded view of the electrical connector shown in FIG. 12.

FIG. 15 is a front perspective view of a printed circuit board having circuitry located proximate an edge of the printed circuit board and being mounted within a housing of an electrical device,

FIG. 16 is a perspective view of the electrical connector shown in FIG. 13 in a position just prior to receiving the edge of the printed circuit board shown in FIG. 15.

FIG. 17 is a perspective view of the electrical connector shown in FIG. 13 in a position after receiving the edge of the printed circuit board shown in FIG. 15.

FIG. 18 is a rear perspective view of a portion of a printed circuit board having circuitry located proximate an edge of the printed circuit board and the electrical connector shown in FIG. 13 in a position just prior to receiving the edge of the portion of the printed circuit board.

FIG. 19 is a rear perspective view of the portion of the printed circuit board shown in FIG. 18, with the electrical connector shown in FIG. 13 in a position after receiving the edge of the portion of the printed circuit board.

FIG. 20 is a section view of the electrical connector shown in FIG. 13 with conductors inserted, the cap in the third position, and in a position just prior to receiving the edge of the portion of the printed circuit board shown in FIG. 18.

FIG. 21 is a section view of the electrical connector shown in FIG. 13 with conductors inserted, the cap in the third position, and in a position just after receiving the edge of the portion of the printed circuit board shown in FIG. 18.

FIG. 22 is a perspective view of an alternative terminal assembly configured to be one piece and which may be used in a preceding housing, such as that shown in FIGS. 7-11.

### DETAILED DESCRIPTION

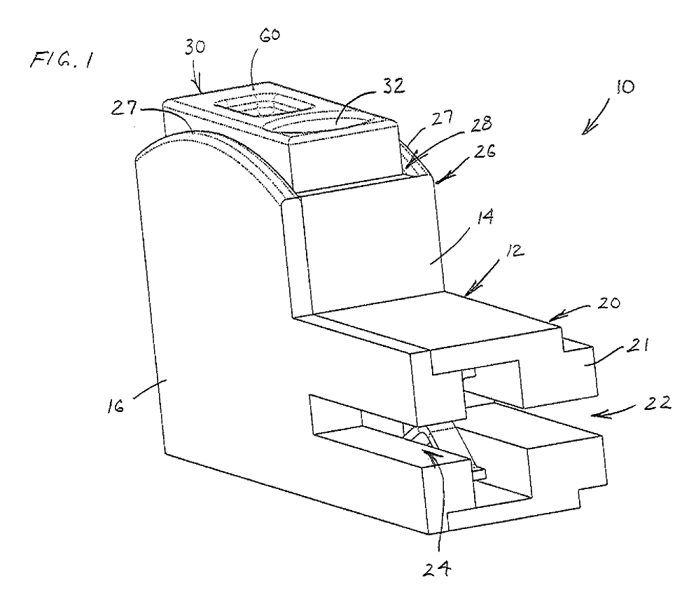

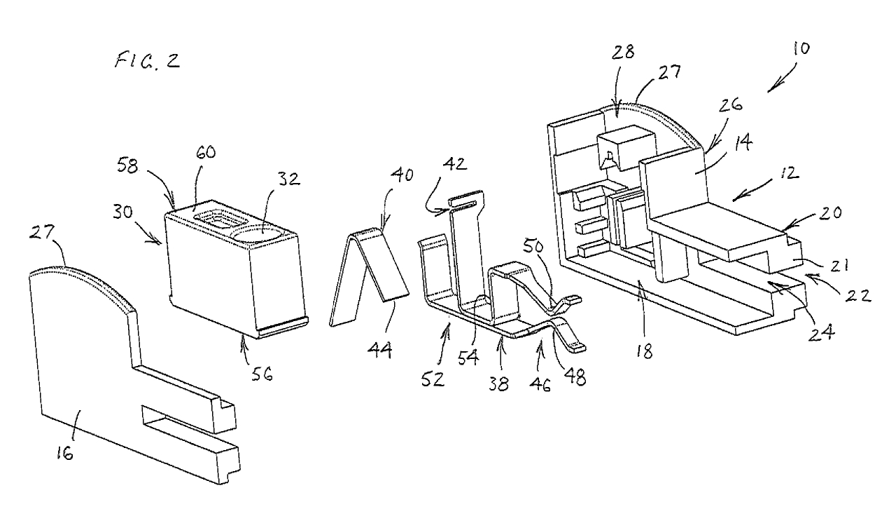

A first example electrical connector 10 is illustrated in FIGS. 1-6. The connector 10 includes a housing 12 having a body 14 and a cover 16, which together define a cavity 18. The housing portions preferably are constructed of non-conductive materials, such as by use of suitable plastics. The housing cover 16 may be attached to the housing body 14 by ultrasonic welding, although it will be appreciated that the pieces of the housing may be divided in a different manner, such as in halves, and may be joined by use of adhesives, snap fit portions, or other suitable mechanical fastening means. The housing 12 includes a first portion 20 having a first face 21. First face 21 includes an opening 22 to a cavity 24 that is adapted to receive an edge of a printed circuit board (not shown) along a first axis. The housing 12 also includes a second portion 26 having a second face 27, and a cap 30. In this example, cap 30 is slidable and the second face 27 includes an opening 28 that is adapted to receive the slidable cap 30. The cap 30 includes a wire entry port 32 adapted to receive a conductor 34 of a stripped end of a wire 36 that may be inserted through the entry port 32 running through the cap 30 along a second axis, wherein the second axis is perpendicular to the first axis. It will be appreciated that the wire 36 could be of varying gauge, such as within the range of about 10 gauge to 20 gauge.

The cavity 18 in the housing 12 receives a terminal assembly 38 which is shielded from the exterior by being disposed entirely within the housing 12. The terminal assembly 38 preferably is constructed so as to include a conductive metal, while still having some resiliency, and may be formed from one or more pieces. A retention member 40 is connected to the terminal assembly 38, such as for instance, by being fitted within a slot 42 in the terminal assembly 38. The retention member 40 preferably is constructed of a resilient material, such as spring metal, and includes a wire contact edge 44. It will be appreciated that the retention member 40 may be loosely connected to the terminal assembly 38, permanently affixed to the terminal assembly, integrally formed with the terminal assembly of a common material, or may not be connected to the terminal assembly at all, but rather may be otherwise separately retained in the housing 12.

The example terminal assembly 38 preferably includes a first portion 46 that extends into the first portion 20 of the housing 12 and has contacts 48, 50 adapted to releasably receive and engage a contact on a printed circuit board, such as in the form of a contact pad or circuit trace (not shown), along a first axis. Terminal assembly 38 also includes a second portion 52 that extends into the second portion 26 of the housing 12 and has a wire contact area 54 adapted to engage an inserted conductor 34 along a second axis, wherein the second axis is perpendicular to the first axis. It will be appreciated that the wire contact edge 44 of the retention member 40 is adapted to releasably engage a contact area of an inserted conductor 34 and that the retention member 40 is configured to apply a compressive force against the contact area of the inserted conductor 34 in a manner in which the conductor 34 is forced into engagement with the wire contact area 54 of the terminal assembly 38, thus achieving a push-in connection. In this example, the terminal assembly 38 benefits by use of a more conductive material while utilizing the spring force of the more resilient retention member 40 to hold the conductor 34 within the housing 12 and against the wire contact area 54 of the terminal assembly 38. With this structure, the conductor 34 is held in a manner in which it is releasable, but the conductor 34 cannot ordinarily be removed without significant force or damage to the retention member 40 or to the conductor 34.

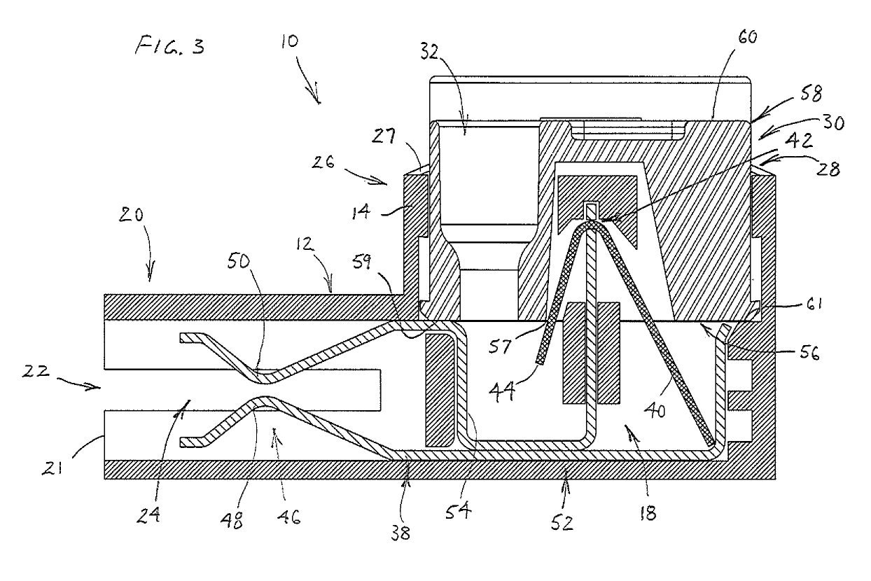

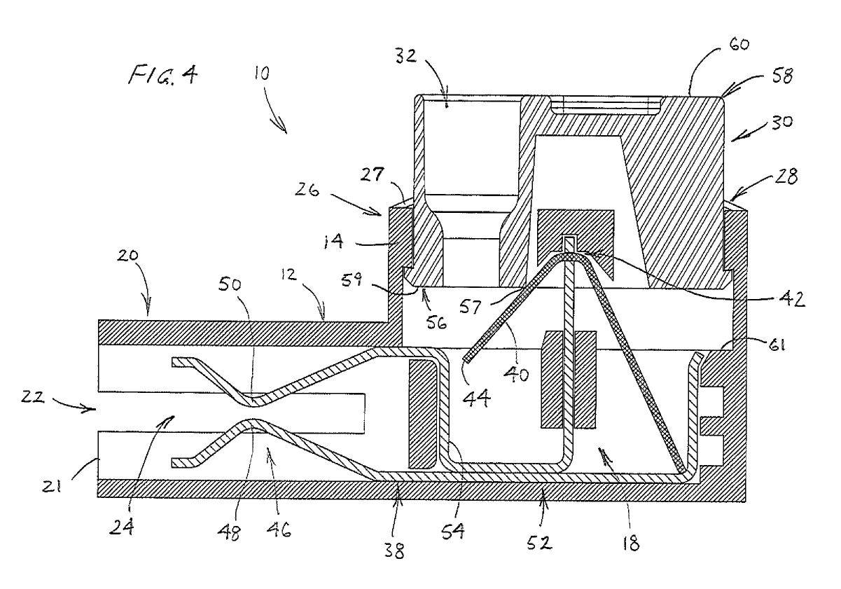

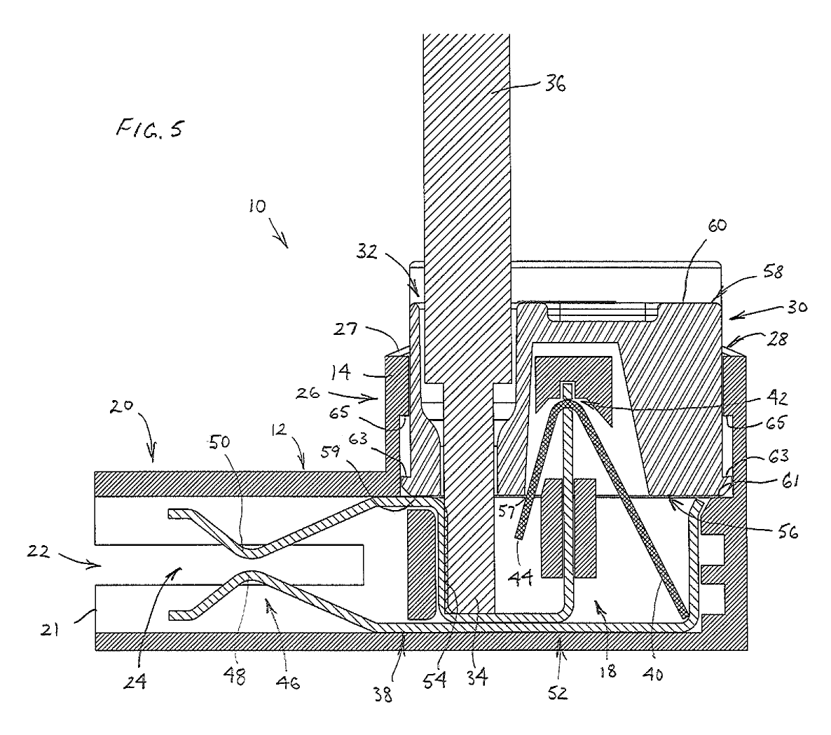

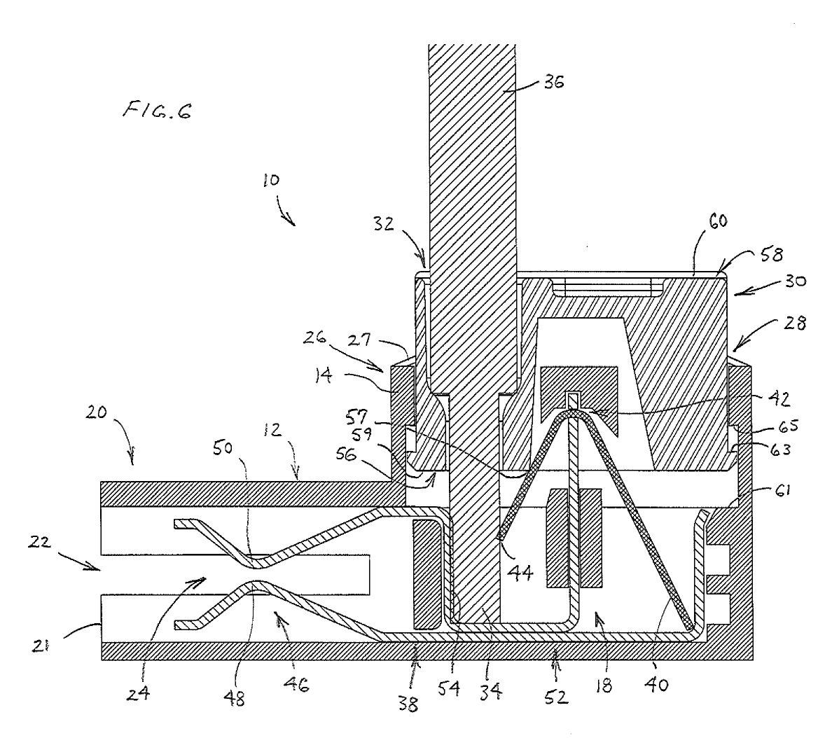

As best seen in FIGS. 3-6, the cap 30 has a bottom portion 56 having a contact edge 57 that is adapted to engage the retention member 40 and a top portion 58 providing a surface 60 for a user to push on the cap 30, and including the wire entry port 32. When no conductor is inserted into the electrical connector 10 along a second axis, the cap 30 may be moved by pressing on the surface 60 on the top portion 58 of the cap 30 to move the cap 30 between a depressed first position, best seen in FIG. 3, and a released second position, best seen in FIG. 4. When the cap 30 is moved toward the first position, a bottom surface 59 of the cap 30 engages and is stopped by the terminal 38, so as not to over-compress and permanently deform the retention member 40. If desired, the housing may be formed with an internal wall 61 to be engaged by the bottom surface 59 of the cap 30, in place of or in addition to stopping against the terminal assembly 38. With the cap 30 moved to the first position, a conductor 34 may be inserted with zero insertion force, as seen in FIG. 5. When a conductor 34 is inserted and the cap 30 is released, it moves under the force of the compressed retention member 40 to a third position, best seen in FIG. 6, where it permits the contact edge 44 of the retention member 40 to engage and retain a conductor 34.

To remove an inserted conductor 34, a user may press on the surface 60 on the top portion 58 of the cap 30 to move the cap 30 from the third position, best seen in FIG. 6 in which it is retaining a conductor 34, to a first position, best seen in FIG. 5 in which it further compresses the retention member 40 and the bottom surface 59 is stopped against the terminal assembly 38. Under such compression, the retention member 40 will be moved to a first position, best seen in FIG. 5, where the contact edge 44 no longer engages the contact area of the conductor 34 and the conductor 34 is releasable so that it may be withdrawn from the cavity 18 of the housing 12. In the example illustrated, when the cap 30 is released, it moves by way of a force generated by the return of the resilient retention member 40 toward a rest position in which protrusions 63 on the sides of the cap 30 engage stop ledges 65 in the housing 12. Thus, this structure is capable of achieving a releasable push-in wire termination. It will be appreciated that the movement of the cap 30 may be affected in a different manner, such as by having a separate resilient member to control positioning of the cap or other configurations to limit the travel of the cap 30 within the housing 12.

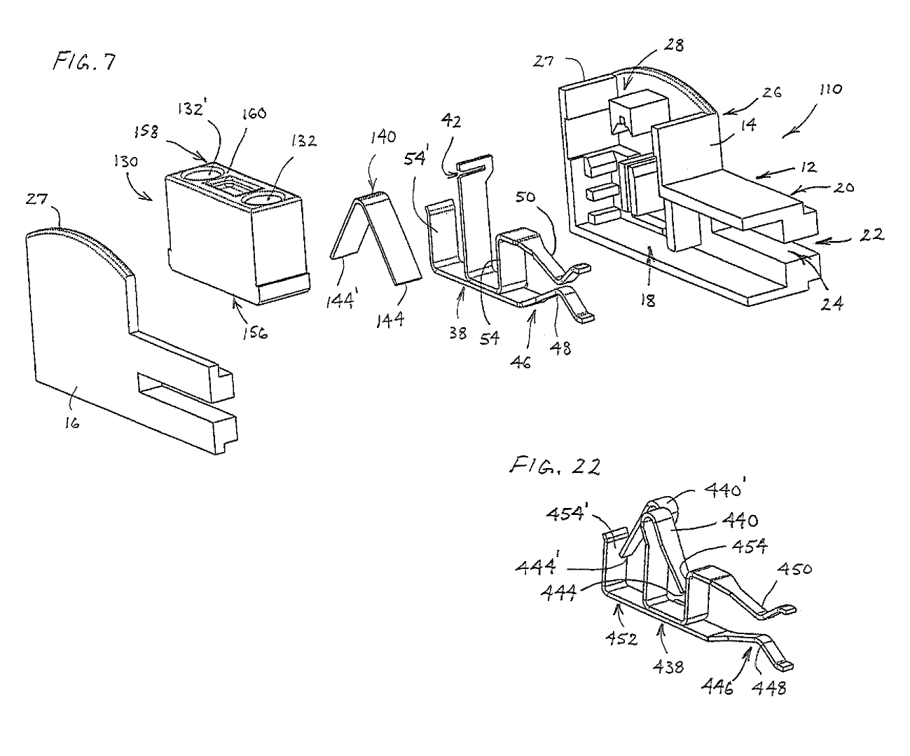

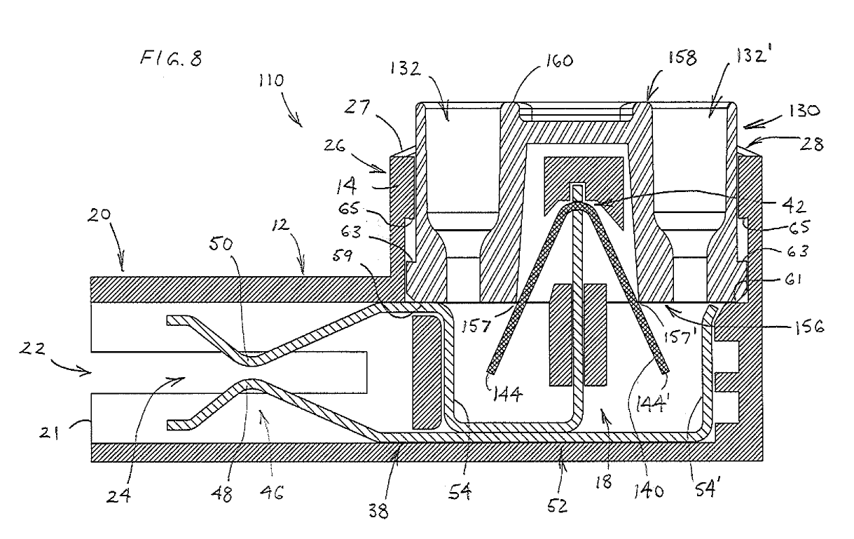

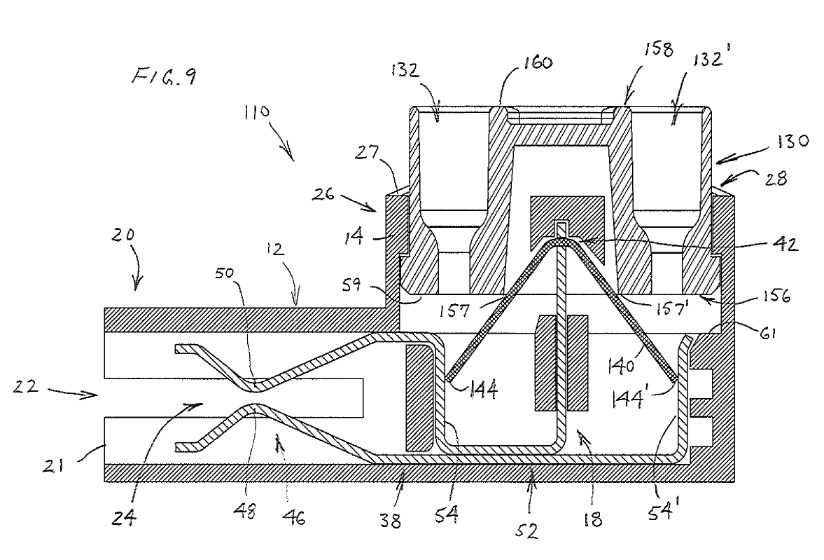

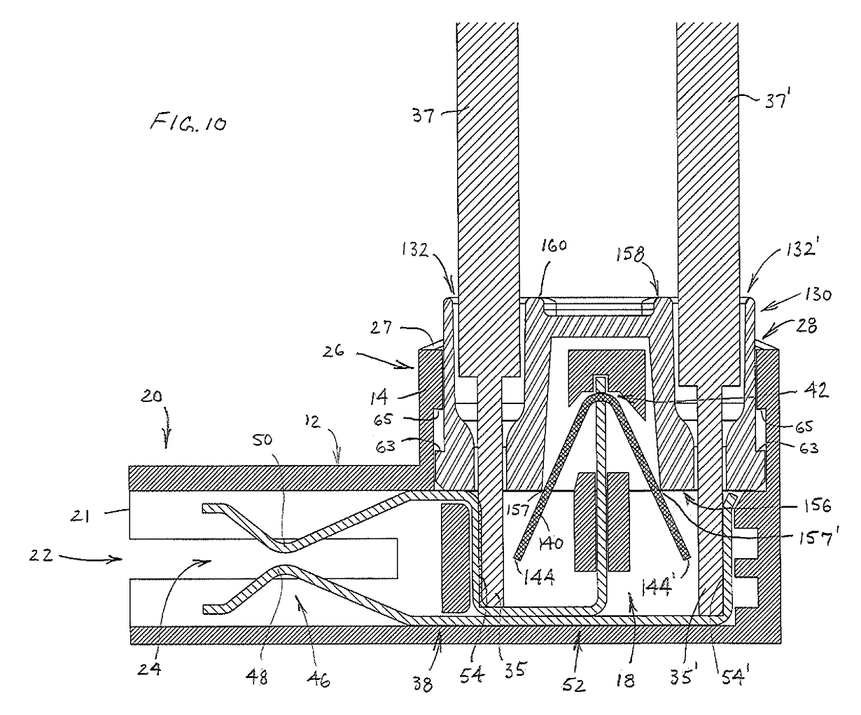

Turning to FIGS. 7-11, another example of an electrical connector 110 is illustrated. In this example, many of the individual components of the connector are similar to those of the connector 10 in FIGS. 1-6, and therefore, such components will be given like reference numerals. However, the cap 130 is different and is adapted to receive more than one conductive stripped end of a wire within two wire entry ports 132, 132′. In this example, two wires 37, 37′ having 35, 35′ are received in the wire entry ports 132, 132′. It will be appreciated that in this example, the wires 37, 37′ are of smaller gauge than is shown in the previous example. However, the wire sizes received in the two wire entry ports 132, 132′ of the cap 130 need not necessarily be of the same or smaller size. In turn, the cap 130 includes a bottom portion 156, a top portion 158 which includes the wire entry ports 132, 132′ and surface 160 for use in moving the cap 130.

In this example, in addition to the terminal assembly 38 including a first portion 46 with conductive contacts 48, 50 adapted to engage a contact on a printed circuit board, such as in the form of a contact pad or circuit trace (not shown), the terminal assembly 38 also includes a second portion 52 with a first wire contact area 54 that is adapted to releasably engage an inserted conductor 35 of a first wire 37, and a second wire contact area 54′ that is adapted to releasably engage a further inserted conductor 35′ of a second wire 37′. Thus, the wire contact area 54 is used to releasably engage the conductor 35 and the wire contact area 54′ is used to releasably engage the conductor 35′, to achieve push-in wire terminations. To assist in retaining both conductors 35, 35′ within the cavity 18 of the housing 12, the retention member 140 includes a first contact edge 144 that engages and releasably retains an inserted conductor 35 and includes a second contact edge 144′ that engages and releasably retains an inserted conductor 35′ in a like manner. Thus, in this example, the retention member 140 is adapted to engage a plurality of conductors.

To be able to release the conductors 35, 35′, the bottom portion 156 of the cap 130 includes two respective contact edges 157, 157′ that engage the retention member 140 at two positions to compress the retention member 140 when the cap 130 is moved to a first position, so as to achieve releasable push-in wire connections. It will be appreciated that the components of this example could include multiple pieces, such as the cap 130 could have a combination of multiple pieces, so as to permit separate insertion and release of the conductors 35, 35′. Similarly, the retention member 140 could be constructed of multiple pieces to permit separate engagement with respective conductors. As with the prior example, the cap 30 is stopped upon downward travel by the bottom surface 59 of the cap 30 contacting the terminal 38 and/or the wall 61 in the housing 12. Also, upon upward movement, the cap 30 is stopped in a rest position by the protrusions 63 on the sides of the cap 30 engaging stop ledges 65 in the housing 12.

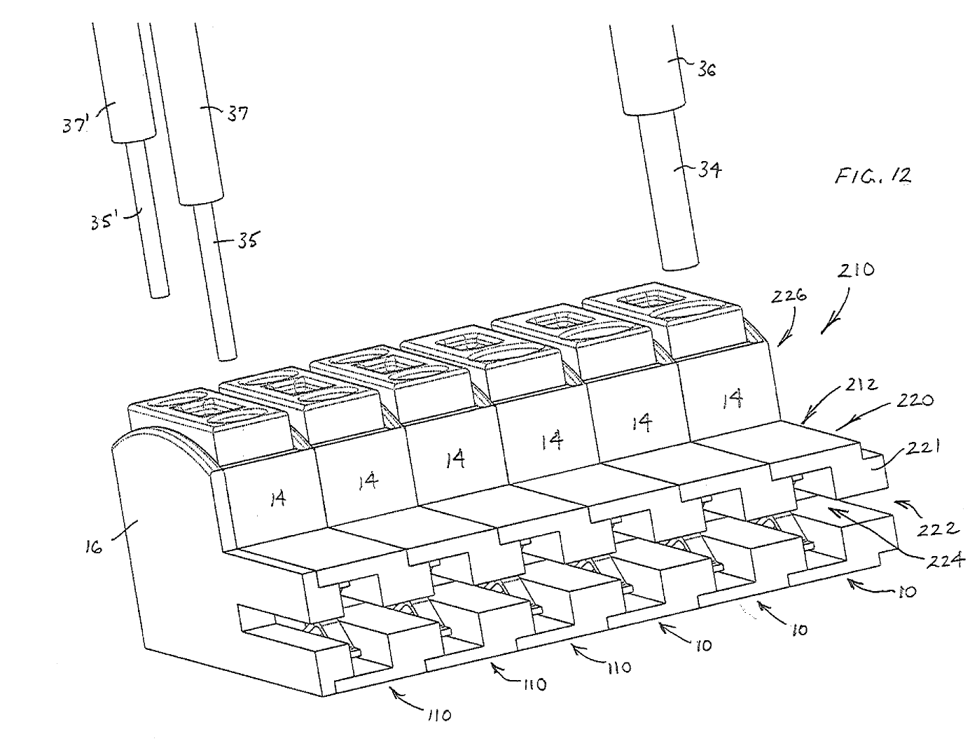

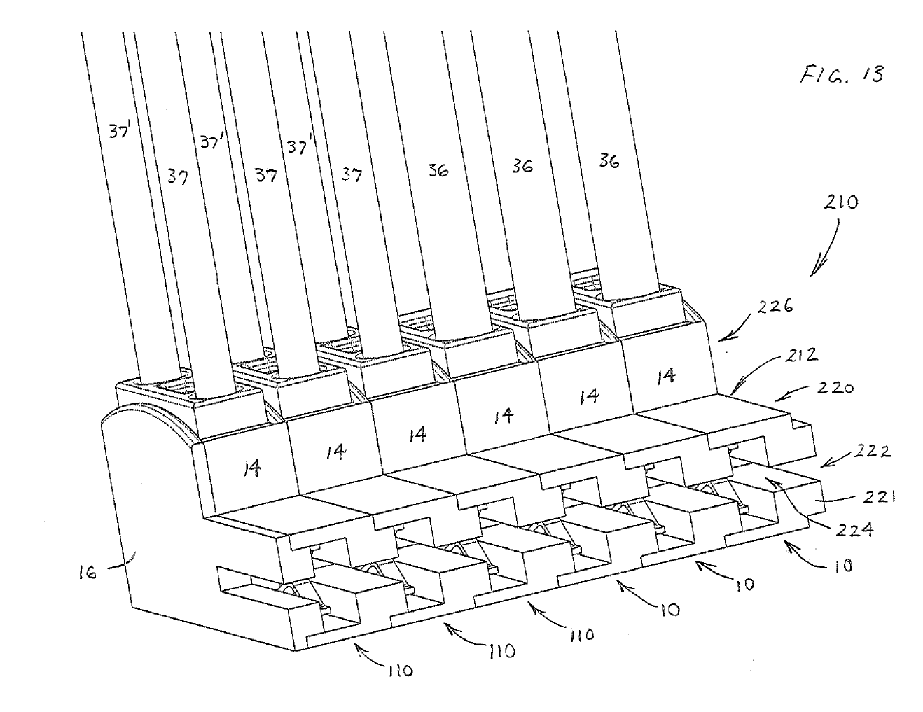

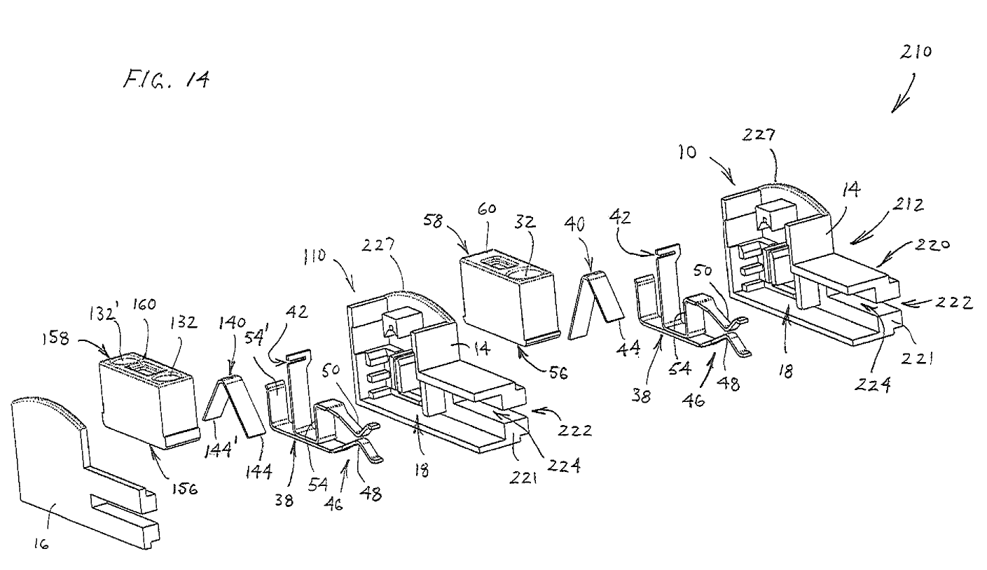

In FIGS. 12-14, another example of an electrical connector 210 is illustrated. The electrical connector 210 is accomplished by stacking and joining together, such as by use of welding, adhesives or suitable mechanical fasteners, a plurality of sections formed by housing bodies 14 and a cover 16. As shown in FIGS. 12-14 it is possible to assemble the different example connectors 10 of FIG. 1-6 and/or example connectors 110 of FIG. 7-11 in any combination, order or pattern, by using the side of the next successive body portion 14 in place of a cover 16 as the housing bodies 14 are stacked, until the final end of the connector 210 is reached, where a cover 16 is installed. It will be appreciated that in this manner a connector 210 having a plurality of sections can accommodate a plurality of circuits. It also will be appreciated that it is possible to effectively combine a plurality of like individual connector sections having substantially identical construction. The description of the other components of the joined electrical connectors 10 and 110 is the same as provided with respect to FIGS. 1-6 and 7-11, respectively, and therefore, such components will be given like reference numerals and the description will not be repeated here for electrical connector 210.

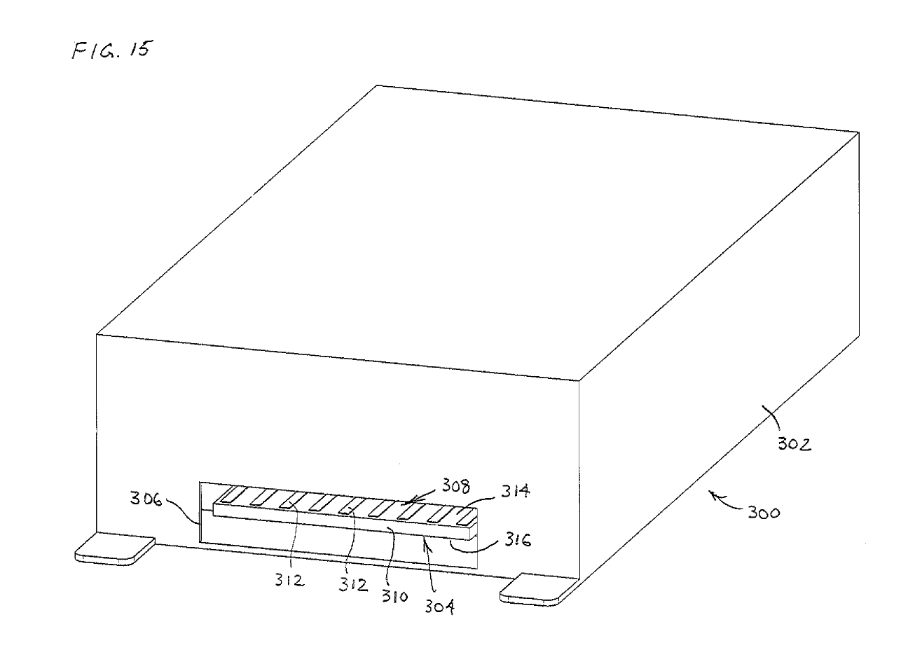

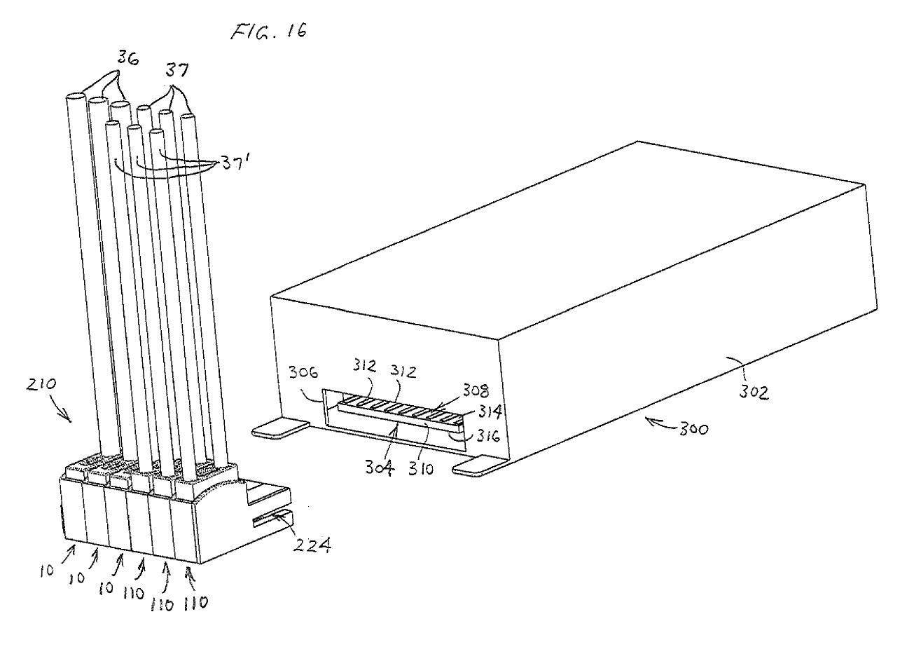

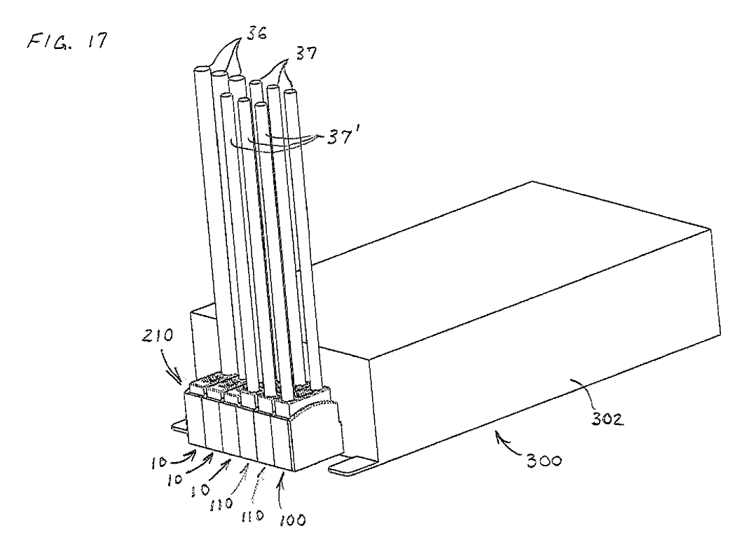

FIGS. 15-17 illustrate a possible use of an electrical connector 210 with an electrical device 300. The electrical device 300 includes a housing 302 within which is mounted a printed circuit board 304 that is accessible through an opening 306 in the housing 302 of the electrical device 300. Electronic circuitry 308 is located proximate an edge 310 of the printed circuit board 304 for receipt in the cavity 224 of the electrical connector 210. The electronic circuitry 308 includes circuit conductors 312 that are in the form of spaced apart contact pads or circuit traces that are located proximate the edge 310 of the printed circuit board 304 on a top face 314 and a bottom face 316 of the printed circuit board 304, and are in alignment with contacts 48, 50 of respective terminal assemblies 38. It will be appreciated that the circuit conductors 312 are not required to be on both the top face 314 and bottom face 316, and instead could be only on the top face 314, on the bottom face 316, or could have a combination of placement on top and bottom faces, such as in an alternating top and bottom configuration.

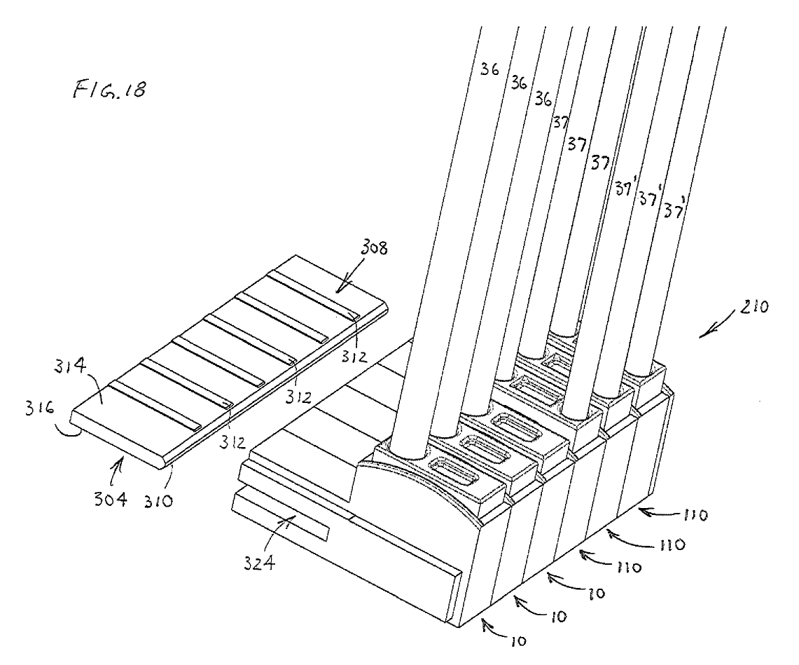

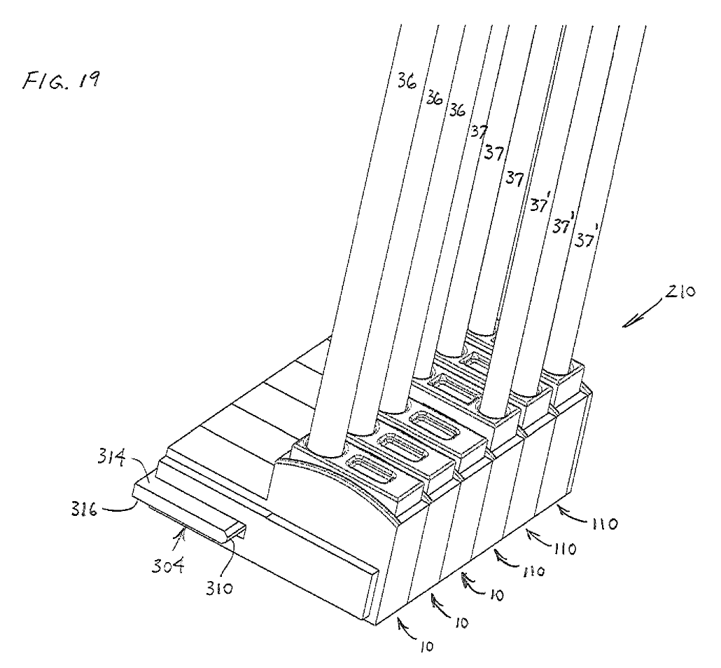

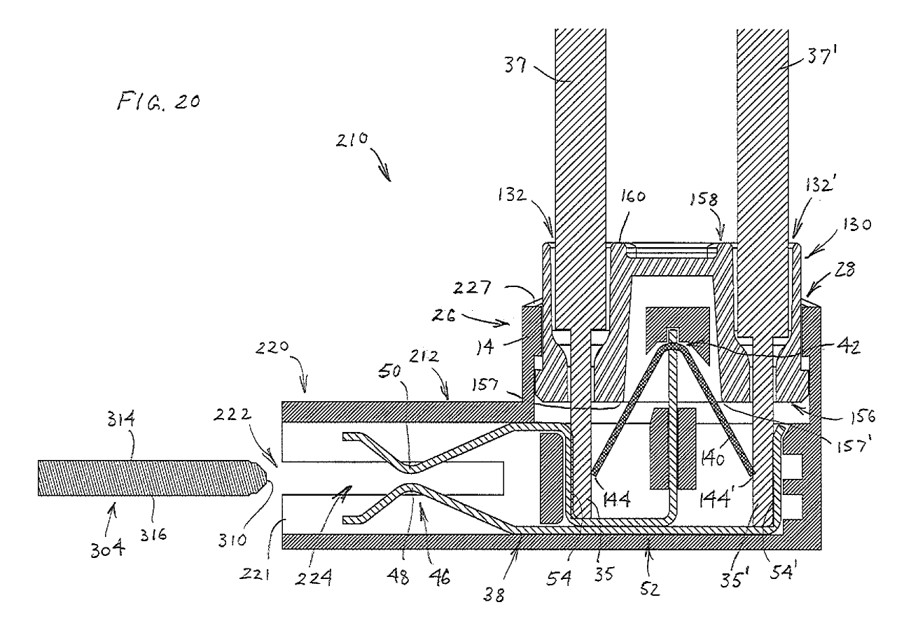

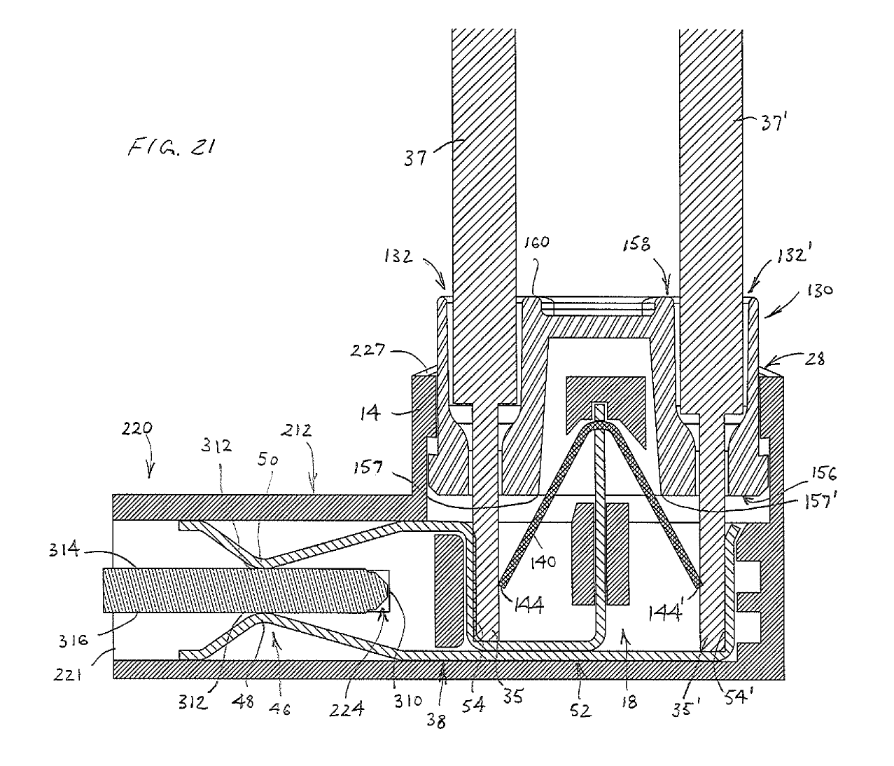

FIGS. 18-21 illustrate the insertion of a portion of the printed circuit board 304 into the cavity 224 in the first face 220 of the housing 212 of the electrical connector 210. The front edge 310 of the printed circuit board 304 is tapered to allow for easy insertion into cavity 224 of the electrical connector 210. Each contact 48 of a terminal assembly 38 will flex downward as the connector 210 slidably receives the printed circuit board 304, and will engage a circuit conductor 312, such as a contact pad or circuit trace, on the bottom face 316 of the printed circuit board 304, creating and electrical connection between the printed circuit board 304 and the terminal assembly 38. Similarly each contact 50 of a terminal assembly 38 will flex upward as it engages a circuit conductor 312 on the top face 314 of the printed circuit board 304, creating an electrical connection between the printed circuit board 304 and the terminal assembly 38.

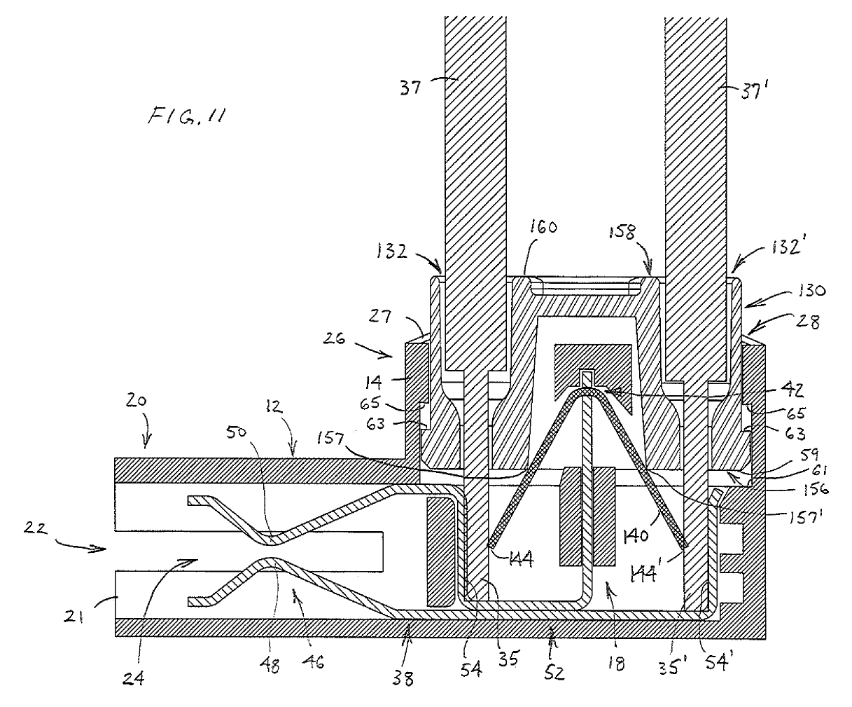

Turning to FIG. 22, an alternative example terminal assembly 438 preferably is constructed so as to include a conductive metal, while still having some resiliency, and may be formed from one or more pieces, such as by stamping and folding the metal. The example terminal assembly 438 may be used in one of the preceding housings, such as in the example shown in FIGS. 7-11. The terminal assembly 438 includes a first portion 446 that extends into a first portion 20 of a housing 12 and has contacts 448, 450 adapted to receive and engage one or more contacts in the form of contact pads or circuit traces on a printed circuit board (not shown). The terminal assembly 438 also includes a second portion 452 that extends into a second portion 26 of the housing 12 and includes wire contact areas 454, 454′ adapted to engage inserted conductors 35, 35′ of stripped ends of wires 37, 37′, similarly to the illustration in FIG. 11.

In this example, the terminal assembly 438 includes integrally formed respective retention members 440, 440′. The retention members 440, 440′ are adapted to engage respective inserted conductors 35, 35′ of stripped ends of wires 37, 37′. As with the prior examples, the retention members 440, 440′ have contact edges 444, 444′ that engage a contact area on a conductor of a stripped end of a wire and force the conductor into engagement with a respective contact area 454′, 454′ of the terminal assembly 438, so as to achieve push-in wire terminations. It will be appreciated that with this example, as with the prior examples, the conductors may be readily releasable to permit removal without significant force or damage to the retention members 440, 440′ or to the conductors. Thus, the retention members 440, 440′ may be moved, such as by the cap 30, to provide releasable engagement between the conductors of the stripped ends of the wires and the terminal assembly 438.

While the present disclosure shows and demonstrates various example electrical connectors that may be adapted for use with electrical devices and systems, these examples are merely illustrative and are not considered to be limiting. It will be apparent to those of ordinary skill in the art that various electrical connectors may be constructed without departing from the scope or spirit of the present disclosure. Thus, although certain examples of apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

I claim:

1. An electrical connector comprising a housing adapted to receive at least one conductor of a stripped end of a wire, the electrical connector further including at least one terminal assembly, wherein the at least one terminal assembly includes a retention member adapted to releasably engage the at least one conductor via a push-in wire termination, with the housing including a cap having a port through which the at least one conductor passes.

2. The electrical connector of claim 1, wherein the housing comprises a first portion having a first face adapted to receive a card edge of a printed circuit board and a second portion having a second face adapted to receive the cap.

3. The electrical connector of claim 2, wherein the first face is in a first plane, the second face is in a second plane and the first and second planes are perpendicular to each other.

4. The electrical connector of claim 1, wherein a first portion of the at least one terminal assembly is adapted to engage a contact pad on a printed circuit board and a second portion of the at least one terminal assembly is adapted to engage the at least one conductor of a stripped end of a wire.

5. The electrical connector of claim 1, wherein the terminal assembly is adapted to be engaged by at least two conductors of stripped ends of at least two wires.

6. The electrical connector of claim 1, wherein the cap is movable and is configured to engage the retention member and to permit zero insertion force wire termination when the cap is in a first position.

7. The electrical connector of claim 1, wherein the cap further comprises at least two wire entry ports.

8. The electrical connector of claim 1, wherein each terminal assembly is comprised of one piece of resilient conductive material.

9. The electrical connector of claim 1, wherein the cap is slidable and in a first position is adapted to compress the retention member of the terminal assembly.

10. The electrical connector of claim 1, wherein the cap is configured to include a plurality of ports adapted to receive a respective plurality of inserted conductors of stripped ends of a plurality of wires.

11. The electrical connector of claim 1, wherein the housing comprises a plurality of sections that accommodate a plurality of circuits.

12. The electrical connector of claim 11, wherein the plurality of sections are substantially of identical construction.

13. The electrical connector of claim 11, wherein each section further comprises a terminal assembly having a retention member for engagement with an inserted conductor.

14. The electrical connector of claim 11, wherein each section further comprises a cap that is configured to slide independently of the cap of each other respective section.

15. An electrical connector comprising a housing having a first portion adapted to receive an edge of a printed circuit board along a first axis and a second portion adapted to receive at least one conductor of a stripped end of a wire along a second axis which is perpendicular to the first axis, the electrical connector further including at least one terminal assembly, wherein a first portion of each terminal assembly is adapted to releasably engage a contact pad on a printed circuit board and a second portion of each terminal assembly is adapted to releasably engage the at least one conductor via a push-in wire termination.

16. The electrical connector of claim 15, wherein the second portion of the housing further comprises at least one wire entry port adapted to provide a zero insertion force wire termination.

17. The electrical connector of claim 16, wherein the second portion of the housing comprises a cap adapted to receive the at least one conductor.

18. The electrical connector of claim 17, wherein the cap is slidable and in a first position is adapted to compress the retention member of the terminal assembly.

19. The electrical connector of claim 17, wherein the cap assembly is configured to slide independently for each respective inserted conductor.

20. The electrical connector of claim 15, wherein the at least one terminal assembly is comprised of one piece of resilient conductive material.

21. The electrical connector of claim 15, wherein the at least one terminal assembly is adapted to be engaged by at least two conductors of stripped ends of at least two wires.

22. The electrical connector of claim 15, wherein the housing comprises a plurality of sections that accommodate a plurality of circuits.

23. The electrical connector of claim 22, wherein the plurality of sections are substantially of identical construction.

24. The electrical connector of claim 15, wherein each terminal assembly comprises a retention member for engagement with an inserted conductor.

25. The electrical connector of claim 24, wherein the retention member and terminal assembly are further comprised of one piece.
